(19) United States
(12) Patent Application Publication
(10) Pub. No.: US 2010/0071003 A1
(43) Pub. Date: Mar. 18, 2010

(54) CONTENT PERSONALIZATION

(75) Inventors: Eyal Bychkov, Hod Hasharon (IL); Uri Ron, Tel Aviv (IL)

Correspondence Address: Soquel Group, LLC, P.O. Box 691, Soquel, CA, 95073, US

(73) Assignee: MODU LTD., Kefar Saba (IL)

(21) Appl. No.: 12/210,199

(22) Filed: Sep. 14, 2008

(51) Int. Cl. H04N 5/445; H04N 7/16

(52) U.S. Cl. 725/46; 725/141

(57) ABSTRACT

A method for dynamic real-time content personalization and display, including collecting data about at least one viewer in the vicinity of a content presentation device, identifying the at least one viewer from the collected data, locating content associated with the identified at least one viewer, and automatically presenting the located content. A system is also presented and claimed.

### FIELD OF THE INVENTION

The field of the present invention is digital media players.

### BACKGROUND OF THE INVENTION

Often, multiple users share the same entertainment device. Family members, for example, may share the same television, the same computer, and the same stereo deck. Some entertainment devices are programmable to automatically play content selected by a user. A user may manually select content to be automatically played, or indicate preferences such as artist, title and genre. When there are multiple users, they may define multiple profiles, each profile indicating preferences of a corresponding user.

A Microsoft Windows user profile, for example, is used to configure personal computer parameter settings for a user, including settings for the Windows environment and settings relating to pictures, video and other such media. To configure his parameter settings, the user defines his profile and stores his preferred content files in a designated directory. Thus if the user wants to have his computer screensaver present a slideshow of his pictures, he must store his pictures in the designated directory. If another user wants to have the screensaver present a slideshow of different pictures, then the other user must store his pictures in a different directory, and configure his profile accordingly, and change the currently active profile of the computer.

It would thus be of advantage for a shared entertainment device to be able to automatically personalize its content presentation according to the preferences of the person viewing the content, without manual intervention.

### SUMMARY OF THE DESCRIPTION

Aspects of the present invention relate to a method and apparatus for automatically personalizing presentation of media content based on the identity of the person enjoying the presentation, without manual intervention, so that the content being presented is the person's preferred content. Embodiments of the present invention may be implemented in a variety of presentation devices, including inter alia digital picture frames, stereo decks, video decks, radios, televisions, computers, and other such entertainment appliances which often play content continuously and uninterruptedly over periods of time.

Embodiments of the present invention detect identities of one or more people enjoying content on a player device at any given time, from IDs received from their transmitters, from biometrics, from voice recognition, or from facial or other images captured by one or more cameras.

Embodiments of the present invention associate media content with people based on their playlists, based on their preferences, based on metadata tags in content files, and by applying face and voice recognition to images and videos.

There is thus provided in accordance with an embodiment of the present invention a method for dynamic real-time content personalization and display, including collecting data about at least one viewer in the vicinity of a content presentation device, identifying the at least one viewer from the collected data, locating content associated with the identified at least one viewer, and automatically presenting the located content.

There is further provided in accordance with an embodiment of the present invention a content presentation device with content personalization functionality, including a data collector, for collecting data about at least one viewer in the vicinity of a content presentation device, a viewer identifier communicatively coupled with the data collector, for identifying the at least one viewer from the data collected by the data collector, a content locator communicatively coupled with the viewer identifier, for locating content associated with the at least one viewer identified by the viewer identifier, and a media player communicatively coupled with the content locator, for automatically presenting the content located by the content locator.

The following definitions are employed throughout the specification.
CONTENT—refers broadly to media content including inter alia e-books, games, pictures, songs, slide shows, television shows, video clips and movies.
ENJOYING CONTENT—refers broadly to listening, watching or interacting with content.
PRESENTATION DEVICE—refers broadly to a content player including inter alia an audio player, a video player, an electronic picture frame, a radio, a television and a game play station.
VIEWER—refers broadly a person who enjoys content presented by a presentation device. Generally, the viewer is in the vicinity of the presentation device.

### BRIEF DESCRIPTION OF THE DRAWINGS

The present invention will be more fully understood and appreciated from the following detailed description, taken in conjunction with the drawings in which:

FIG. 1 is a simplified flowchart of a method for dynamic real-time content personalization and display, in accordance with an embodiment of the present invention; and

FIG. 2 is a simplified block diagram of a presentation device having content personalization functionality, in accordance with an embodiment of the present invention.

### DETAILED DESCRIPTION

Embodiments of the present invention relate to a media presentation device with functionality for automatically presenting content that is associated with one or more viewers of the content. The presentation device identifies the viewer, and in turn presents content that is determined to be associated with the identified viewer.

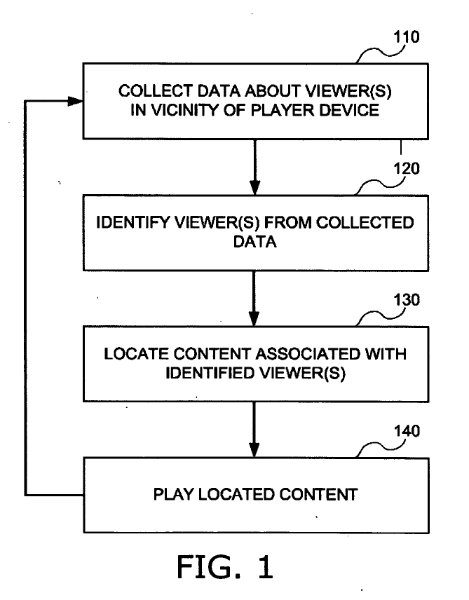

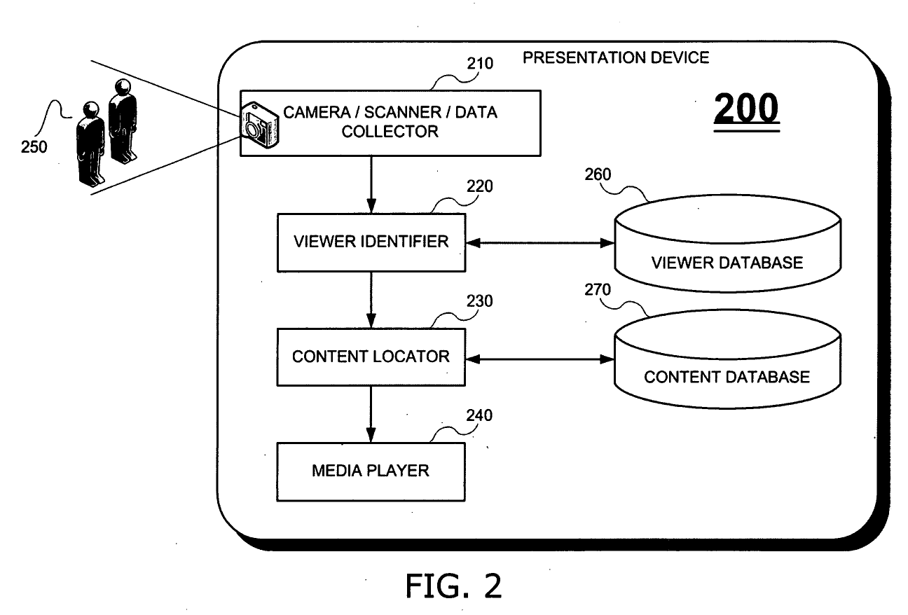

Reference is now made to FIG. 1, which is a simplified flowchart of a method for dynamic real-time content personalization and display, in accordance with an embodiment of the present invention. In conjunction with FIG. 1, reference is also made to FIG. 2, which is a simplified block diagram of a presentation device 200 having content personalization functionality, in accordance with an embodiment of the present invention. Steps 110, 120, 130 and 140 shown in FIG. 1 are performed by correspondingly numbered components of presentation device 200 shown in FIG. 2, which include a data collector 210, a viewer identifier 220, a content locator 230, and a media player 240.

According to an embodiment of the present invention, player device 200 is a passive device, which automatically presents content uninterruptedly without manual intervention. Presentation device 200 may be a digital picture frame, which automatically presents a slide show of pictures. Presentation device 200 may be a stereo or video deck, which automatically plays music or movies. Presentation 200 may be a radio, which plays broadcast sound. Presentation device 200 may be a television, which automatically plays broadcast TV shows. Presentation device 200 may be a computer, which automatically presents a screensaver when it is in an idle state.

At step 110, data collector 210 collects data about viewers 250 in its vicinity. Step 110 may be implemented in many different ways.

Step 110 may be implemented by receiving electronic IDs from viewers' devices. For example, viewers 250 may have cell phones with Bluetooth IDs, near-field communication (NFC) IDs, radio frequency IDs (RFID), bar code IDs, or other such identifiers. For such implementation, data collector 210 is a corresponding Bluetooth receiver, NFC receiver, RFID receiver, bar code scanner, or such other receiver or scanner.

Step 110 may be implemented by scanning viewer biometrics; e.g., by scanning an eye iris, scanning a fingerprint, or scanning a palm. Alternatively, step 110 may be implemented by recording a voice. For such implementation, data collector 210 is a corresponding iris scanner, fingerprint scanner, palm scanner, or voice recorder.

Step 110 may be implemented by analyzing images captured by a still or video camera located on or near the player device. For such implementation, data collector 210 is a camera.

If no viewers are detected at step 110, then the method repeats step 110 periodically, until one or more viewers are detected.

At step 120 viewer identifier 220 identifies the viewers 250 in its vicinity from the data collected at step 110. For example, viewer identifier 220 may look up an electronic ID in a viewer database 260. Alternatively, viewer identifier 220 may employ iris recognition, fingerprint recognition, palm recognition or voice recognition software. Alternatively, viewer identifier 220 may employ face recognition software to identify one or more persons in captured images. E.g., viewer identifier 220 may use the OKAO Vision™ face sensing software developed and marketed by OMRON Corporation of Kyoto, Japan, or the Face Sensing Engine developed and marketed by Oki Electric Industry Co., Ltd. of Tokyo, Japan.

At step 130 content locator 230 locates content associated with the viewers 250 identified at step 120. Content locator may consult a content database 270 that indexes content according to viewer association. Association of content with viewers may be performed in many different ways. Audio files may be associated with viewers based on existing playlists associated with viewers, and based on preset viewer preferences such as viewer preferred genres, and by identifying the viewer's voice in the files. Image and video files may be associated with viewers by cataloging the files according to people included in the images and videos, based on face recognition and other such recognition techniques. Software, such as the content-based image organization application developed and marketed by Picporta, Inc. of Ahmedabad, India, and the visual search application developed by Riya, Inc. of Bangalore, India, may be used to do the cataloging. Alternatively, audio, image and video files may be associated with viewers based on informational metadata tags in the files. The Facebook® system, developed and marketed by Facebook, Inc. of Palo Alto, Calif., enables users to tag people in photos by marking areas in the photos.

A summary and evaluation of face recognition technologies that may be used for automatic cataloging of image collections is presented in Corcoran, P. and Costache, G., “The automated sorting of consumer image collections using face and peripheral region image classifiers”, IEEE Trans. Consumer Electronics, Vol. 51, No. 3, August 2005, pgs. 747-754.

It will be appreciated by those skilled in the art that viewer database 260 may be local to presentation device 200, as indicated in FIG. 2, or may be remotely accessible via a network, or may be partially local and partially remote. Viewer identifier 220 may be an internal component of presentation device 200, or an external component communicatively coupled with presentation device 200.

It will further be appreciated by those skilled in the art that content database 270 may be local to presentation device 200, as indicated in FIG. 2, or may be remotely accessible via a network, or may be partially local and partially remote. For example, the Kodak EasyShare EX-1011 Digital Picture Frame, developed and manufactured by the Eastman Kodak Company of Rochester, N.Y., presents content that is stored remotely on a PC or at an online photo-sharing service. Content locator 230 may be an internal component of presentation device 200, or an external component communicatively coupled with presentation device 200.

At step 140 the content located at step 130 by content locator 230, is automatically presented by media player 240. In case more than one viewer was identified at step 120, media player 240 gives priority to content that is associated with the multiple identified viewers. Additionally, or alternatively, media player 240 rotates its presentation between content associated with each identified viewer. As such, the presentation time is divided between content presented for the multiple viewers.

In accordance with another embodiment of the present invention, specific content is designated as default content, and when one or more viewers are identified, media player 240 rotates its presentation between default content and content associated with each identified viewer.

In an embodiment of the present invention, media player 240 uses predefined rules for content to be presented, based on viewers identified at step 120. For example, pre-designated content is prevented from being presented if one or more pre-designated viewers are identified as being in the vicinity of media player 240.

The method of FIG. 1 periodically returns to step 110, in order to regularly determine if one or more previously identified viewers leave the vicinity of player 200, and if one or more new viewers enter the vicinity.

As such it will be appreciated by those skilled in the art that embodiments of the present invention dynamically search for new viewers in the vicinity of player 200, and present relevant content in real-time, quickly in response to identification of such new viewers.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A method for dynamic real-time content personalization and display, comprising:
collecting data about at least one viewer in the vicinity of a content presentation device;
identifying the at least one viewer from the collected data;
locating content associated with the identified at least one viewer; and
automatically presenting the located content.

2. The method of claim 1 wherein said collecting data comprises receiving at least one ID from at least one electronic device in possession of the at least one viewer, and wherein said identifying comprises identifying the at least one received ID.

3. The method of claim 2 wherein the at least one ID includes a Bluetooth ID, or a radio frequency ID (RFID), or a near-field communication (NFC) ID.

4. The method of claim 1 wherein said collecting data comprises scanning at least one bar code corresponding to the at least one viewer, and wherein said identifying comprises identifying the at least one scanned bar code.

5. The method of claim 1 wherein said collecting data comprises scanning at least one eye iris, or at least one fingerprint, or at least one palm of the at least one viewer, and wherein said identifying comprises identifying the at least one scanned iris, or the at least one scanned fingerprint, or the at least one scanned palm, respectively.

6. The method of claim 1 wherein said collecting data comprises recording at least one voice of the at least one viewer, and wherein said identifying comprises identifying the at least one recorded voice.

7. The method of claim 1 wherein said collecting data comprises capturing at least one photograph of the at least one viewer, and wherein said identifying comprises recognizing at least one face in the at least one captured photograph.

8. The method of claim 1 wherein said collecting data comprises capturing at least one video frame of the at least one viewer, and wherein said identifying comprises recognizing at least one face in the at least one captured video frame.

9. The method of claim 1 wherein said locating content comprises reading playlists.

10. The method of claim 1 where said locating content comprises reading content file metadata tags.

11. The method of claim 1 wherein the at least one viewer comprises a plurality of viewers, and wherein said automatically presenting comprises rotating presenting between content associated with each one of the plurality of viewers.

12. The method of claim 1 wherein the at least one viewer comprises a plurality of viewers, and wherein said automatically presenting comprises presenting content that is associated with more than one of the plurality of viewers.

13. The method of claim 1 wherein said automatically presenting comprises preventing presentation of pre-designated content if the at least one viewer comprises one or more pre-designated viewers.

14. A content presentation device with content personalization functionality, comprising:
a data collector, for collecting data about at least one viewer in the vicinity of a content presentation device;
a viewer identifier communicatively coupled with said data collector, for identifying the at least one viewer from the data collected by said data collector;
a content locator communicatively coupled with said viewer identifier, for locating content associated with the at least one viewer identified by said viewer identifier; and
a media player communicatively coupled with said content locator, for automatically presenting the content located by said content locator.

15. The content presentation device of claim 14 wherein said viewer identifier is physically coupled with said data collector.

16. The content presentation device of claim 14 wherein said viewer identifier is remote from said data collector, and is wirelessly coupled with said data collector.

17. The content presentation device of claim 14 further comprising a viewer database for storing viewer information, and wherein said viewer identifier accesses said viewer database to identify the at least one viewer.

18. The content presentation device of claim 17 wherein said viewer database is physically coupled with said viewer identifier.

19. The content presentation device of claim 17 wherein said viewer database is wirelessly coupled with said viewer identifier.

20. The content presentation device of claim 17 wherein said viewer database is remote from said viewer identifier.

21. The content presentation device of claim 14 wherein said content locator is physically coupled with said viewer identifier.

22. The content presentation device of claim 14 wherein said content locator is remote from said viewer identifier, and is wirelessly coupled with said viewer identifier.

23. The content presentation device of claim 14 wherein said content locator is physically coupled with said media player.

24. The content presentation device of claim 14 wherein said content locator is remote from said media player, and is wirelessly coupled with said media player.

25. The content presentation device of claim 14 further comprising a content database for storing content information, and wherein said content locator accesses said content database to locate the content associated with the at least one viewer.

26. The content presentation device of claim 25 wherein said content database is physically coupled with said content locator.

27. The content presentation device of claim 25 wherein said content database is wirelessly coupled with said content locator.

28. The content presentation device of claim 25 wherein said viewer database is remote from said content locator.

29. The content presentation device of claim 14 wherein said data collector comprises a receiver for receiving at least one ID from at least one electronic device in possession of the at least one viewer, and wherein said viewer identifier comprises an ID identifier.

30. The content presentation device of claim 29 wherein said receiver is a Bluetooth receiver, or a radio frequency ID (RFID) receiver, or a near-field communication (NFC) receiver.

31. The content presentation device of claim 14 wherein said data collector comprises a barcode scanner, and wherein said viewer identifier comprises a barcode identifier.

32. The content presentation device of claim 14 wherein said data collector comprises an eye iris scanner, or a fingerprint scanner, or a palm scanner, and wherein said viewer identifier comprise an iris identifier, a fingerprint identifier, or a palm identifier, respectively.

33. The content presentation device of claim 14 wherein said data collector comprises a voice recorder, and wherein said viewer identifier comprises a voice recognizer.

34. The content presentation device of claim 14 wherein said data collector comprises a camera, and wherein said viewer identifier comprises a face recognizer.

35. The content presentation device of claim 14 wherein said media player is an audio player or a video player or a slideshow presenter.

36. The content presentation device of claim 14 wherein said media player is a digital picture frame.

37. The content presentation device of claim 14 wherein said media player is a computer screensaver renderer.

38. The content presentation device of claim 14 wherein said media player is a radio or a television.

39. The content presentation device of claim 14 wherein said media player is a game play station.

40. The content presentation device of claim 14 wherein said media player is an e-book reader.
